(19) United States
(12) Patent Application Publication
(10) Pub. No.: US 2024/0167782 A1
(43) Pub. Date: May 23, 2024

(54) PIN PUNCH

(71) Applicant: New Revo Brand Group, LLC, Plymouth, MN (US)

(72) Inventors: Ryan Jacobson, Andover, MN (US); Paul Otto, Minneapolis, MN (US)

(73) Assignee: New Revo Brand Group, LLC, Plymouth, MN (US)

(21) Appl. No.: 18/362,142

(22) Filed: Jul. 31, 2023

Related U.S. Application Data
(63) Continuation-in-part of application No. 29/860,909, filed on Nov. 23, 2022.

(51) Int. Cl. F41A 35/00; B25F 1/00; F41A 17/64

(52) U.S. Cl. CPC F41A 35/00; B25F 1/006; F41A 17/64

(57) ABSTRACT

A pin punch comprised of an elongate body having a length defined by a first axis, at least one hole in a top half of the elongate body, and a magnet embedded in the elongate body and adjacent to the at least one hole, wherein the magnet is positioned and configured to transiently retain a removable firearm pin positioned in the at least one hole. The at least one hole may be at least one of a hole positioned in a side of, and perpendicular to the first axis of, the elongate body, or a pin hole positioned in a top face of, and parallel to the first axis of, the elongate body.

### FIELD OF THE INVENTION

This disclosure relates to a pin punch. More specifically, it relates to a versatile pin punch starter used to install and/or remove pins in a firearm.

### BACKGROUND OF THE INVENTION

After use and throughout their lives, firearms require maintenance, and a significant portion of firearm maintenance requires the removal of pieces and parts of the firearm in order to complete cleaning and repair. Many of these pieces and parts are held in place with pins, and it is common to remove the firearm pins in order to disassemble the firearm for maintenance. To properly reassemble the firearm, users have to insert pins back into their designated positions. Often, this requires the use of a set of pin punches or pin punch starters to accommodate the various sizes and reduce damage of pins. Further, installation of the pins can pose problems due to the difficulties inherent in insertion of small components (for example, holding on to a short or easily breakable pin while it is hammered into place). Therefore, a tool is needed that can eliminate the need for multiple pin punch starters and that can mitigate the difficulties present during the reassembly process by helping to hold the pins in place near their insertion points on a firearm.

### SUMMARY OF THE INVENTION

The present disclosure relates to a pin punch starter used to install and/or remove pins in a firearm. In an illustrative but non-limiting example, the disclosure provides a pin punch that can include an elongate body having a length defined by a first axis, at least one hole in a top half of the elongate body, and a magnet embedded in the elongate body and adjacent to the at least one hole, wherein the magnet can be positioned and configured to transiently retain a removable firearm pin positioned in the at least one hole. The at least one hole can be at least one of a hole positioned in a side of, and perpendicular to the first axis of, the elongate body, or a pin hole positioned in a top face of, and parallel to the first axis of, the elongate body.

In some cases, the at least one hole can be defined by a large pin receiver, the large pin receiver can be perpendicular to the first axis, and the magnet can be positioned adjacent the large pin receiver.

In some cases, the at least one hole can be part of a set of pin holes, the set of pin holes can be circumferentially positioned on the top face, and the magnet can be centrally positioned between the set of pin holes. Further, every pin hole of the set of pin holes can be of a different diameter than every other pin hole. Alternatively, or additionally, every pin hole of the set of pin holes can be of a different length than every other pin hole.

In some cases, the pin punch can further comprise an attachment assembly. Further, the attachment assembly can be comprised of a spring-loaded ball detent having a ball detent housing and a ball, and an attachment assembly receiver positioned in the elongate body.

In some cases, the pin punch can be combined with a tool. Further, the pin punch can be storable inside the tool. The tool may be a hammer, and the pin punch can be storable in a handle of the hammer. Additionally, the pin punch can be further comprised of a spring-loaded ball detent located near a bottom portion of the pin punch, the hammer handle can have an interior groove inside the handle configured to accept at least a portion of the spring-loaded ball detent, and a tab can be located on a side of the pin punch, opposite the spring-loaded ball detent. The hammer handle can include a punch opening on a bottom surface of the hammer handle, and a tab opening on a side of the hammer handle, wherein the tab of the pin punch is accessible through the tab opening.

In some cases, the at least one hole of the pin punch is both of the hole positioned in the side of, and perpendicular to the first axis of, the elongate body, and the pin hole positioned in the top face of, and parallel to the first axis of, the elongate body. The hole positioned in the side of the elongate body may be defined by a large pin receiver, and the large pin receiver can be perpendicular to the first axis. The pin hole positioned in the top face of the elongate body may be part of a set of pin holes, and the set of pin holes can be circumferentially positioned on the top face. The magnet may be comprised of at least two magnets, wherein a first of the at least two magnets can be positioned adjacent the large pin receiver, and a second of the at least two magnets can be centrally positioned between the set of pin holes.

Further, the elongate body may be further comprised of a main body and a punch head, the punch head can be connectable to a top portion of the main body, the main body can be comprised of a main body housing, the large pin receiver positioned through the main body, and a main body magnet that is the first of the at least two magnets, and the punch head can be comprised of a punch head body, the set of pin holes that are circumferentially positioned on the punch head, and a punch head magnet that is the second of the at least two magnets. The punch head can be comprised of a metal, a pin can be located within a pin hole of the set of pin holes, and the punch head magnet can retain the pin in the pin hole.

Additionally, the punch head can be further comprised of a punch head connector on a bottom portion of the punch head, wherein the punch head connector may be structured and configured to connect to the main body. Further, the main body can be further comprised of a punch head receptacle on a top portion of the main body, wherein the punch head receptacle may be structured and configured to connect to the punch head. The punch head connector and punch head receptacle can be threadedly connectable such that the punch head connector is a threaded, male connector and the punch head receptacle is a female threaded receptacle. In some cases, the punch head receptacle can be adjacent the large pin receiver, and the main body magnet can be positioned on an opposing side of the large pin receiver. The punch head receptacle may be internal to the main body and may be positioned above the large pin receiver, and the main body magnet may be internal to the main body and positioned below the large pin receiver.

In another illustrative but non-limiting example, the disclosure provides a tool that can include a pin punch and a hammer. The pin punch can include a main body, a punch head, and a spring-loaded ball detent comprised of a ball and a ball detent housing. The main body may have a main body housing with a length defined by a first axis, a large pin receiver defining a through hole positioned through the main body, wherein the large pin receiver is perpendicular to the first axis, and a main body magnet positioned adjacent the large pin receiver. The punch head may have a punch head body, wherein a set of pin holes are circumferentially positioned on the punch head, a punch head magnet is centrally positioned between the set of pin holes, and the punch head is connectable to a top portion of the main body. The spring-loaded ball detent may be located near a bottom portion of the pin punch. The hammer may include a hammer head and a handle. The handle may have an interior space inside which the pin punch is storable, a punch opening on a bottom surface of the handle, and an interior groove in the interior space configured to accept at least a portion of the spring-loaded ball detent.

In another illustrative, but non-limiting example, the disclosure provides a method for using a pin punch that can include inserting a pin into a pin hole of a set of pin holes of a pin punch, aligning the pin with a firearm pin hole, and providing blunt force to an end of the pin punch that is opposite the pin to at least partially install the pin in the firearm. The pin punch may have a punch head that is connectable to a top portion of a main body of the pin punch, the set of pin holes may be circumferentially positioned on a top portion of the punch head, and a punch head magnet may be centrally positioned between the set of pin holes. In some embodiments, the method further includes inserting the pin punch into a handle of a hammer, wherein the handle has an interior space inside which the pin punch is storable, and a punch opening on a bottom surface of the handle.

### BRIEF DESCRIPTION OF THE DRAWINGS

FIG. 1 is a rear perspective view of a pin punch starter with storage tool.

FIG. 2 is a left side view of the pin punch starter.

FIG. 3 is a rear view of the pin punch starter.

FIG. 4 is a right side view of the pin punch starter.

FIG. 5 is a front view of the pin punch starter.

FIG. 6 is a rear perspective view of the pin punch starter.

FIG. 7 is a front perspective view of the pin punch starter.

FIG. 8 is a top perspective view of the pin punch starter.

FIG. 9 is a rear perspective view of the pin punch starter stored in a tool.

FIG. 10 is a rear, bottom view of the tool of FIG. 9 with the pin punch starter removed.

FIG. 11 is a cross-sectional view of the pin punch starter and tool of FIG. 9.

FIG. 12 illustrates the use of the pin punch starter and tool of FIG. 9 on a traditional pin with a firearm.

FIG. 13 illustrates the use of the improved pin punch starter on a firearm.

### DETAILED DESCRIPTION

The present disclosure relates to a pin punch starter used to install and/or remove pins in a firearm. Various embodiments of the pin punch starter will be described in detail with reference to the drawings, wherein like reference numerals represent like parts and assemblies throughout the several views. Reference to various embodiments does not limit the scope of the pin punch starter disclosed herein. Additionally, any examples set forth in this specification are not intended to be limiting and merely set forth some of the many possible embodiments for the pin punch starter. It is understood that various omissions and substitutions of equivalents are contemplated as circumstances may suggest or render expedient, but these are intended to cover applications or embodiments without departing from the spirit or scope of the disclosure. Also, it is to be understood that the phraseology and terminology used herein are for the purpose of description and should not be regarded as limiting.

Some embodiments of the pin punch starter disclosed herein include features that accommodate a wide range of pins and that enable storage of the pin punch within a tool that can also be used for work upon a firearm. More specifically, the pin punch starter can include an elongate body, at least one hole in a top half of the elongate body, and a magnet embedded in the elongate body and adjacent to the at least one hole. Therefore, when a pin is inserted into the at least one hole, the pin can be held in place. This transient retention allows a user to easily align the pin with a pin receptacle in a firearm and hold the pin in place while it is hammered at least partially into place by applying force on an opposite end of the pin punch starter.

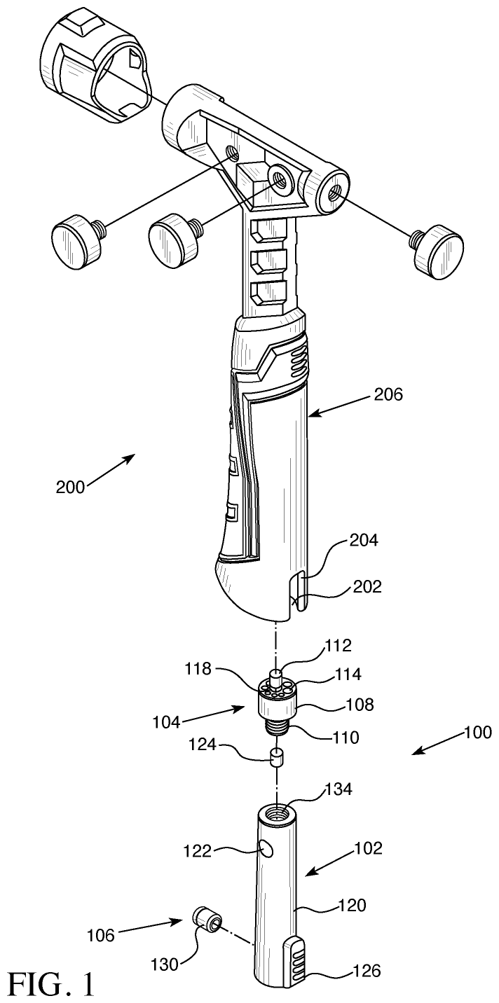

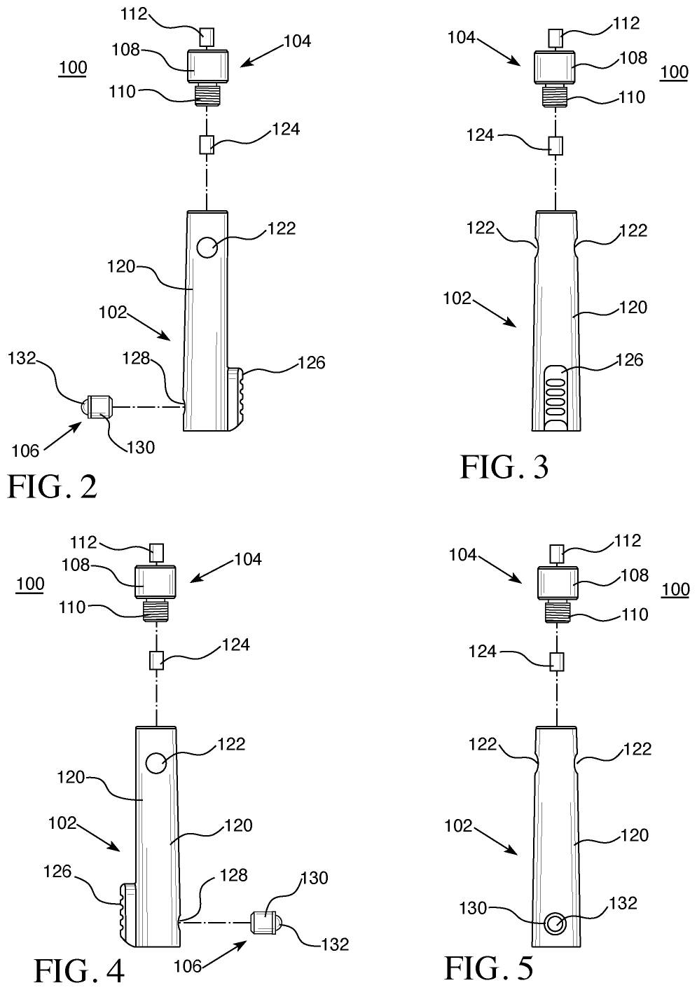

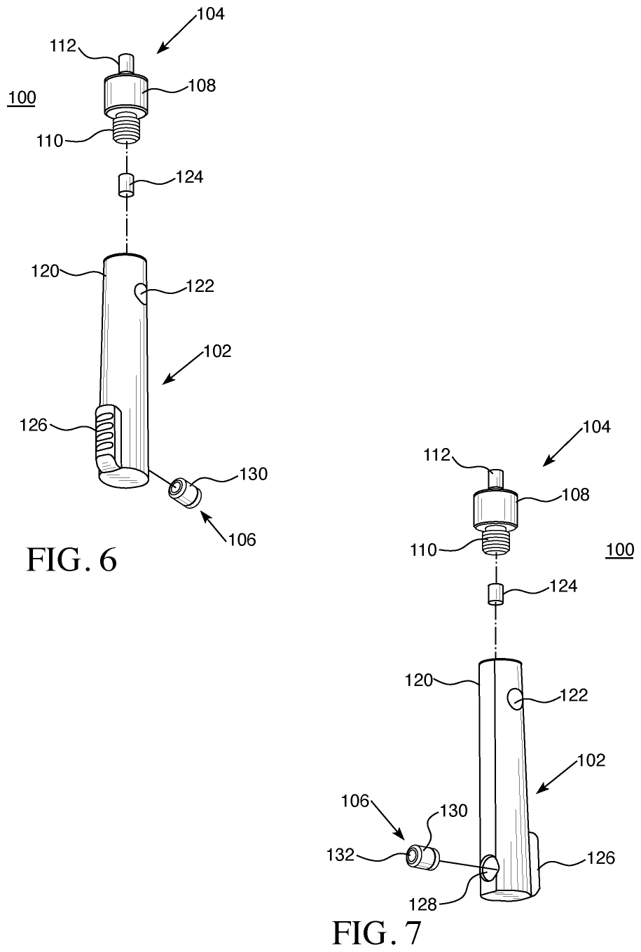

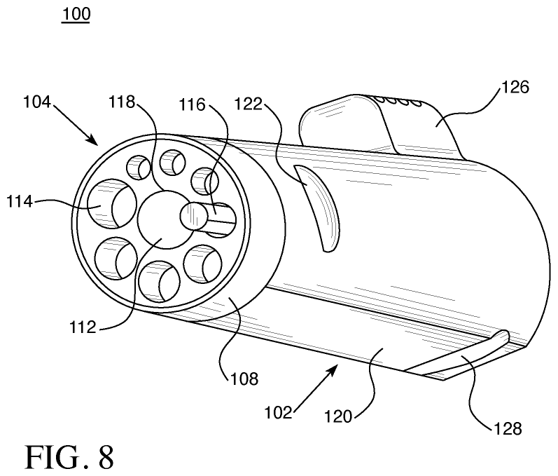

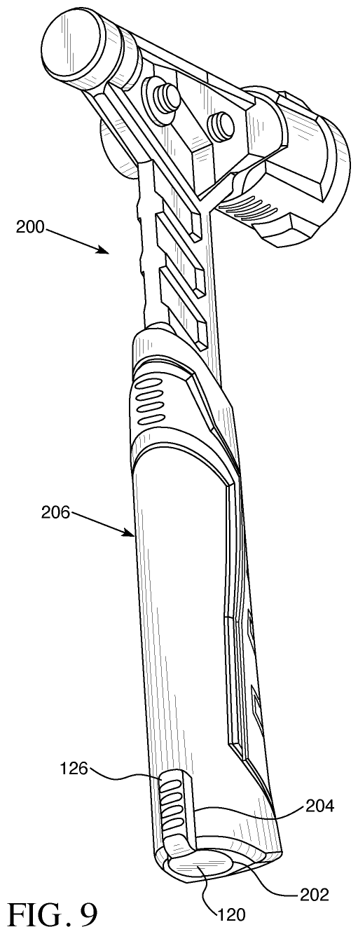

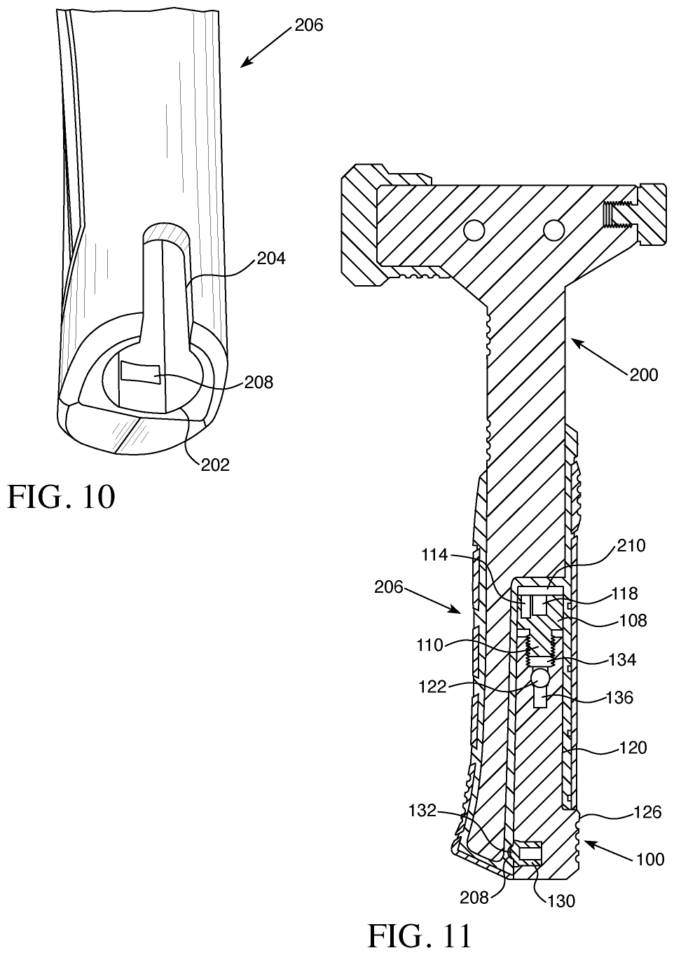

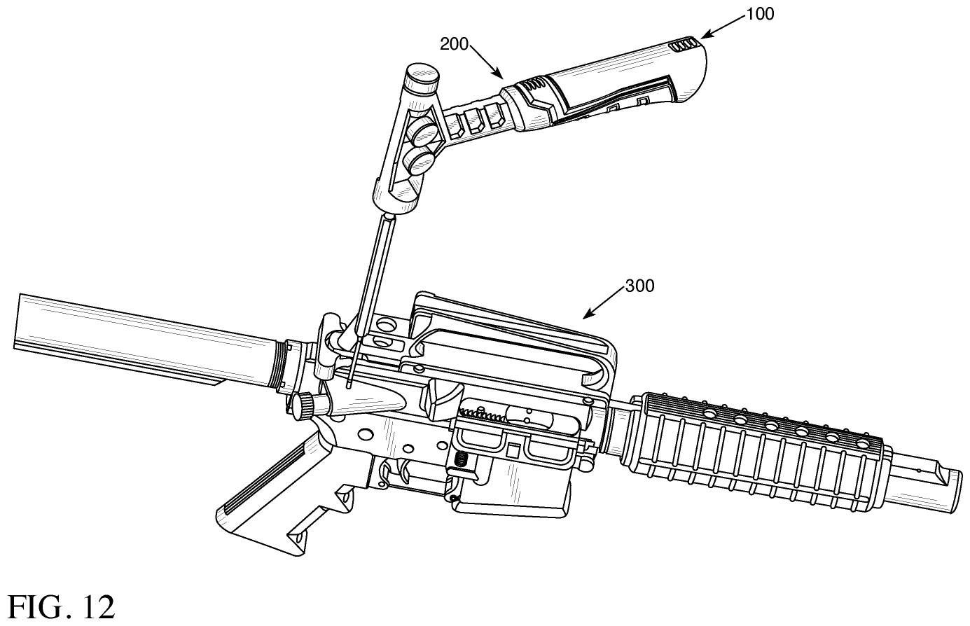

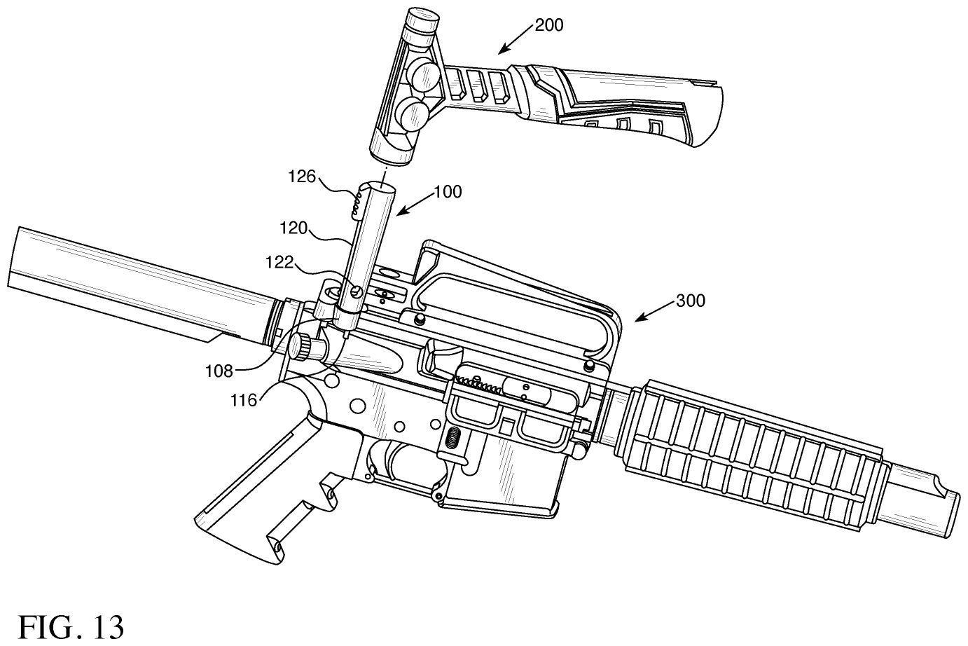

FIGS. 1-13 illustrate various views of an example of a pin punch and/or tool for storage of the pin punch according to the present disclosure. FIG. 1 is a rear perspective view of a pin punch starter with storage tool. FIG. 2 is a left side view of the pin punch starter. FIG. 3 is a rear view of the pin punch starter. FIG. 4 is a right side view of the pin punch starter. FIG. 5 is a front view of the pin punch starter. FIG. 6 is a rear perspective view of the pin punch starter. FIG. 7 is a front perspective view of the pin punch starter. FIG. 8 is a top perspective view of the pin punch starter. FIG. 9 is a rear perspective view of the pin punch starter stored in a tool. FIG. 10 is a rear, bottom view of the tool of FIG. 9 with the pin punch starter removed. FIG. 11 is a cross-sectional view of the pin punch starter and tool of FIG. 9. FIG. 12 illustrates the use of the pin punch starter and tool of FIG. 9 on a traditional pin with a firearm. FIG. 13 illustrates the use of the improved pin punch starter on a firearm.

Generally, the pin punch is roughly cylindrical with a longer length compared to its diameter, although one end of the pin punch may have a smaller circumference than an opposite end. In some embodiments, the pin punch can include a main body and a punch head, wherein at least one of the main body and the punch head have a hole for receipt of a firearm pin, and further wherein a magnet can be embedded adjacent to the at least one hole to transiently retain a removable firearm pin positioned in the hole. In some cases, the pin punch can be stored within a storage cavity of a larger tool, such as a hammer. The main body and the punch head can both be comprised of the same or different rigid material(s) of they can be comprised of a combination of materials. For example, the main body of the pin punch can be plastic, and the punch head can be metal such as, but not limited to, steel, brass, or nickel.

As illustrated in FIG. 1, pin punch 100 can be comprised of main body 102 having large pin receiver 122 adjacent to main body magnet 124, and punch head 104 having pin holes 114 surrounding punch head magnet 112. In embodiments where the pin punch is storable within or pairable to a tool, pin punch 100 may further include attachment assembly 106 for retention within tool 200 and may also include tab 126 so that when the pin punch is stored in the tool, the user has a means for removing the pin punch from its storage within the tool.

As illustrated in FIG. 13, the pin punch can be used to assist with pin insertion into a firearm. To guide firearm pins while they are being inserted into the firearm, the pin punch can include at least one hole in a top half of its elongate body and the at least one hole can be, for example, a hole positioned in a side of, and perpendicular to the first axis of, the elongate body and/or a pin hole positioned in a top face of, and parallel to the first axis of, the elongate body. Regardless of the position of the at least one hole, the pin punch can include a magnet embedded in the elongate body and adjacent to the at least one hole. The purpose of the magnet is to transiently retain a removable firearm pin that is positioned in the at least one hole.

In some embodiments, the at least one hole can be defined by large pin receiver 122, which can be perpendicular to a first axis that is defined by the length of the elongate body of pin punch 100. The magnet can be main body magnet 124 and can be positioned in main body magnet hole 136, which can be adjacent large pin receiver 122, as illustrated in FIG. 11. Adjacent, as defined herein, means an object/feature sharing an edge or having an edge near or close to the edge of another object/feature such that no other objects can or do intercept the space between the two objects/features that are adjacent each other. As illustrated in FIG. 11, main body magnet 124 within main body magnet hole 136 can be positioned adjacent to, and underneath, large pin receiver 122.

In some embodiments, the at least one hole can be part of a set of pin holes 114, which can be circumferentially positioned on a top/upper face of pin punch 100. The magnet can be punch head magnet 112 and can be centrally positioned between or within the set of pin holes 114 such that it is adjacent to or approximately adjacent to each pin hole. More specifically, as illustrated in FIG. 8, punch head magnet 112 can be housed in central hole 118, which can be centered on the top face of pin punch 100. Pin holes 114 can also be located on the top face of pin punch 100, such that a top of central hole 118, which houses punch head magnet 112, and a top of pin holes 114 can all be on the same plane. Pin holes 114 can be spaced laterally away from punch head magnet 112 such that they are centered on a circumferential axis surrounding punch head magnet 112. Therefore, each pin hole can have a first spacing (defined as the space between the circumference of pin punch and a first side of each pin hole) that is approximately equivalent to a second spacing (defined as the space between the circumference of the central hole and a second side of each pin hole). In some cases, each pin hole may be equidistant from the magnet such that the opposing sides of the pin holes are differing distances from a circumference of the pin punch. In other cases, each pin hole may be equidistant from the circumference of the pin punch such that the opposing sides of the pin holes are differing distances from the magnet.

In embodiments where the at least one hole is a set of pin holes 114, each pin hole in the pin holes can be of a different diameter than every other pin hole. Additionally, or alternatively, each pin hole in pin holes 114 can be of a different length than every other pin hole. For example, each pin hole of pin holes 114 may have the same length or depth but have a different diameter. Alternatively, each pin hole of pin holes 114 may have the same diameter but different lengths or depths. In another embodiment, each pin hole of pin holes 114 may have both different diameters and different lengths or depths. For example, a wider diameter in a pin hole may correspond to a deeper length. No restrictions are envisioned for the variety of combinations available to accommodate the variations in differently sized firearm pins.

In some embodiments, the at least one hole can include both a hole positioned in the side of, and perpendicular to the first axis of, the elongate body, and a pin hole positioned in the top of face of, and parallel to the first axis of, the elongate body. The hole in the side of the elongate body can be defined by large pin receiver 122, and the large pin receiver can also be perpendicular to the first axis, as described above. The pin hole can be part of a set of pin holes 114, and the set of pin holes can be circumferentially positioned on the top face of pin punch 100, as described above. In this embodiment, there can be at least two magnets, wherein a first of the at least two magnets is main body magnet 124 that is positioned adjacent large pin receiver 122, as described above, and a second of the at least two magnets is punch head magnet 112 that is centrally positioned between the set of pin holes 114, as described above.

In some cases, main body magnet 124 and punch head magnet 112 are aligned along a vertical axis. Therefore, a plurality of the components of pin punch may be positioned in a vertical line. For example, punch head magnet 112 can be located within central hole 118, which can be centrally located within a top portion of punch head 104 such that magnet 112 and hole 118 directly vertically align with, in descending order, punch head connector 110 (described in more detail below), punch head receptacle 134 (described in more detail below), large pin receiver 122, main body magnet hole 136, and main body magnet 124.

As mentioned above, in some embodiments, the elongate body of pin punch 100 is comprised of main body 102 and punch head 104. Punch head 104 can be connectable to a top portion of main body 102, as illustrated in FIGS. 1-8. Additionally, punch head 104 can include punch head connector 110 on a bottom portion of the punch head, such that the punch head connector is structured and configured to connect to main body 102, as described in more detail below. In some embodiments, while main body 102 can be comprised of any type of rigid material (ex: plastics, metals, or high durometer rubbers, silicones or polyurethanes, etc.), punch head 104 can be comprised of a magnetic material such as, but not limited to, a metal (ex. steel, brass, or nickel). Therefore, when a pin is located within a pin hole of the set of pin holes 114, punch head magnet 112 can retain the pin in the pin hole. This enables a user to turn pin punch 100 at an angle, such as sidewise or upside down, without the pin falling out, which is important if a user is positioning a pin for installation on a top or side portion of a firearm that is positioned on a surface or mount.

Main body 102 can be comprised of main body housing 120, large pin receiver 122 positioned through the main body, and main body magnet 124 (within main body magnet hole 136) that can be one of at least two magnets. Positioned through, as defined herein, means a hole, channel, or space that completely penetrates through the solid body in which it is located. Therefore, large pin receiver 122 is interpreted as being a hole that completely penetrates through main body 102. In addition to main body housing 120, large pin receiver 122, and main body magnet 124 in main body magnet hole 136, main body 102 can include punch head receptacle 134 on a top portion of the main body, such that the punch head receptacle is structured and configured to pair/connect to punch head 104. Positionally, main body magnet hole 136, main body magnet 124, large pin receiver 122, and punch head receptacle 134 may all be located in a top half of main body 102.

Punch head 104 can be comprised of punch head body 108, the set of pin holes 114 that can be circumferentially positioned on the punch head, and punch head magnet 112 within central hole 118, which can be one of at least two magnets. Punch head body 108 may be approximately cylindrical, as illustrated in FIGS. 2-5, with approximately flat top and bottom faces. The top face of punch head body 108 may include openings to pin holes 114 and central hole 118. As described above, punch head 104 may also include punch head connector 110, which can be a threaded, male connector protruding from the bottom face of punch head body 108. Punch head connector 110 may be cylindrical and may have a smaller diameter than the diameter of punch head body 108.

Punch head connector 110, as described above, and punch head receptacle 134 can be threadedly connectable. For example, punch head connector 110 can be a threaded, male connector, and punch head receptacle 134 can be a threaded, female receptacle that is sized and shaped to threadedly receive the threaded, male connector of the punch head connector. In some embodiments, when main body 102 and punch head 104 are threadedly connected via punch head connector 110 and punch head receptacle 134, the bottom face of punch head body 108 and the top face of main body housing 120 may be in contact with each other.

In some embodiments, punch head receptacle 134 can be adjacent large pin receiver 122, and main body magnet 124 can be positioned on an opposing side of the large pin receiver. More specifically, punch head receptacle 134 can be internal to main body 102 and can be positioned above large pin receiver 122. Therefore, main body magnet 124 can be internal to main body 102 and can be positioned below large pin receiver 122.

As mentioned above, the pin punch can be combined with (such as storable within, or pairable to) a tool. More specifically, pin punch 100 may further include attachment assembly 106 to aid with retention to tool 200. For example, attachment assembly 106 can include a spring-loaded ball detent and attachment assembly receiver 128. The spring-loaded ball detent and attachment assembly receiver 128 may be located near a bottom portion of pin punch 100, as illustrated in FIGS. 7 and 11. More specifically, attachment assembly receiver 128 may be comprised of a channel in main body housing 120 with an opening along the circumferential side of main body housing 120, and at least a portion of the spring-loaded ball detent may be located within the channel of attachment assembly receiver 128.

The spring-loaded ball detent may be comprised of ball detent housing 130 and ball 132, as illustrated in FIGS. 2, 4, and 7. Ball 132 can be fixed within ball detent housing 130, which can be cylindrical, such that it will not inadvertently fall out of the housing if pin punch 100 is rotated in a way that positions ball to be facing the ground. In some embodiments, a spring (such as, but not limited to, a compression spring) can be positioned within ball detent housing 130 to provide constant outward force on ball 132. The spring-loaded ball detent can fit within attachment assembly receiver 128, as mentioned above.

Attachment assembly receiver 128 can be positioned within the elongate body of main body housing 120. More specifically, receiver 128 can be located near a bottom portion of the elongate body of main body housing 120 of pin punch 100, as illustrated in FIGS. 2, 4, and 7. The spring-loaded ball detent can be permanently installed in receiver 128 or it may be removable such that it is replaceable. In some embodiments, part or all of ball detent housing 130 can fit within receiver 128 and at least a portion of ball 132 can protrude past the plane of main body housing 120, as illustrated in FIG. 11. Therefore, in cases where pin punch 100 is storable inside tool 200, insertion of the pin punch into the tool can cause ball 132 to be compressed such that an outermost surface of ball 132 is forced into the same plane as main body house 120. Ball 132 can then provide frictional resistance against an internal surface of tool 200 to hold pin punch 100 within the tool.

In some embodiments, pin punch 100 may also include tab 126 to assist with removal of the pin punch from its storage within tool 200. Tab 126 can be located on a side of pin punch 100 opposite the spring-loaded ball detent, as illustrated in FIGS. 2, 4, 6-7, and 11. Tab 126 can be an approximately rectangular protrusion, as illustrated in FIG. 3, and can be taller than it is wide. Therefore, when pin punch 100 is stored inside tool 200, tab 126 can protrude at least partially out from the surface plane of the tool, as illustrated in FIG. 9, so that a user can pull on the tab to remove the pin punch. In some cases, to aid with removal of pin punch 100 from tool 200, tab 126 can include ridges on its outermost face, as illustrated in FIGS. 1-4.

In some embodiments, tool 200 can have handle 206, and pin punch 100 can be storable within the handle. For example, if tool 200 is a hammer, pin punch 100 can be storable within the hammer handle. Handle 206 can include punch opening 202 and tab opening 204 that lead into main cavity 210 where pin punch 100 can be stored.

Punch opening 202 can be on or near a bottom surface of handle 206 and can be structured and configured to receive pin punch 100. More specifically, punch opening 202 can be sized and shaped to accommodate the largest diameter portion of main body housing 120 of pin punch 100. Therefore, a user can insert pin punch 100 through punch opening 202 and into handle 206 of tool 200 by inserting the top of the pin punch into the punch opening and sliding it upwards until it is fully inserted in main cavity 210. Once inserted, the bottom of pin punch 100 may be flush with the bottom of handle 206 such that they are on the same plane, as illustrated in FIG. 9. To accommodate tab 126, handle 206 may include tab opening 204. Tab opening 204 can be located on a side of handle 206. As mentioned above, tab 126 of pin punch 100 can be accessible through tab opening 204 to enable a user to easily remove the pin punch from tool 200.

To retain pin punch 100 inside tool 200, handle 206 can also have interior groove 208 on an interior portion of the handle that is configured to accept at least a portion of the spring-loaded ball detent (for example, ball 132 of the spring-loaded ball detent). More specifically, as illustrated in FIGS. 10-11, interior groove 208 may be located on an interior side of handle 206 opposite tab opening 204 and may include a notch that is sized to receive at least a portion of ball 132 when pin punch 100 is completely inserted into tool 200. In some cases, the size of interior groove 208 may be small enough that ball 132 cannot completely insert, thus leaving the spring at least partially compressed and continuing to push ball 132 against an interior of handle 206. In this way, pin punch 100 is held inside tool 200 due to tension (of ball pushed up against handle interior) and mechanical means (ball 132 partially wedged in interior groove 208).

In one embodiment, an entire tool is provided that is comprised of a pin punch and a hammer. The pin punch can include a main body, a punch head, and a spring-loaded ball detent. The main body can include a main body housing with a length defined by a first axis, a large pin receiver defining a through hole positioned through the main body, wherein the large pin receiver is perpendicular to the first axis, and a main body magnet positioned adjacent the large pin receiver. The punch head can include a punch head body, wherein a set of pin holes are circumferentially positioned on the punch head, a punch head magnet is centrally positioned between the set of pin holes, and the punch head is connectable to a top portion of the main body. The spring-loaded ball detent can be comprised of a ball and a ball detent housing, wherein the spring-loaded ball detent is located near a bottom portion of the pin punch. The hammer can include a hammer head and a handle. The hammer handle can have an interior space inside which the pin punch is storable, a punch opening on a bottom surface of the handle, and an interior groove in the interior space configured to accept at least a portion of the spring-loaded ball detent.

As mentioned above, the pin punch can be used to install pins in a firearm. Therefore, a user may use pin punch 100 by inserting a pin into one pin hole from a set of pin holes of the pin punch, aligning the pin with a firearm pin hole, as illustrated in FIG. 13, and providing blunt force to an end of the pin punch that is opposite the pin to at least partially install the pin in firearm 300. The blunt force can be provided by tool 200, such as a hammer. In some embodiments, further steps can be taken such as inserting the pin punch into a handle of a tool, such as the hammer, wherein the handle has an interior space inside which the pin punch is storable and a punch opening on a bottom surface of the handle.

As mentioned above, the pin punch can have a punch head that is connectable to a top portion of a main body of the pin punch. Further, the set of pin holes can be circumferentially positioned on a top portion of the punch head. Additionally, the punch head magnet can be centrally positioned between the set of pin holes.

In some cases, once the pin is at least partially installed in firearm 300, a supplemental pin punch can be used to completely drive the pin into the firearm. More specifically, a user can align the supplemental pin punch with the partially installed pin and use tool 200, which can be a hammer, to provide blunt force to an end of the supplemental pin punch that is opposite the pin to fully install the pin in firearm 300, as illustrated in FIG. 12. In some cases, a user can simply use tool 200 in combination with a supplemental pin punch to fully install the pin in firearm 300. However, various positions of firearm 300 during maintenance activities may make it difficult to use a standard pin punch. Therefore, the magnetic pin punch described herein may provide an additional benefit by better-retaining various sizes of pins during installation in a firearm.

The various embodiments described above are provided by way of illustration only and should not be construed to limit the claims attached hereto. Those skilled in the art will readily recognize various modifications and changes that may be made without following the example embodiments and applications illustrated and described herein and without departing from the true spirit and scope of the following claims.

What is claimed is:

1. A pin punch comprising:
an elongate body having a length defined by a first axis;
at least one hole in a top half of the elongate body, wherein the at least one hole is at least one of
a hole positioned in a side of, and perpendicular to the first axis of, the elongate body, or
a pin hole positioned in a top face of, and parallel to the first axis of, the elongate body; and
a magnet embedded in the elongate body and adjacent to the at least one hole, wherein
the magnet is positioned and configured to transiently retain a removable firearm pin positioned in the at least one hole.

2. The pin punch of claim 1, wherein
the at least one hole is defined by a large pin receiver,
the large pin receiver is perpendicular to the first axis, and
the magnet is positioned adjacent the large pin receiver.

3. The pin punch of claim 1, wherein
the at least one hole is part of a set of pin holes,
the set of pin holes are circumferentially positioned on the top face, and
the magnet is centrally positioned between the set of pin holes.

4. The pin punch of claim 3, wherein every pin hole of the set of pin holes is of a different diameter than every other pin hole.

5. The pin punch of claim 3, wherein every pin hole of the set of pin holes is of a different length than every other pin hole.

6. The pin punch of claim 1, further comprising an attachment assembly.

7. The pin punch of claim 6, wherein the attachment assembly is comprised of
a spring-loaded ball detent having a ball detent housing and a ball, and
an attachment assembly receiver positioned in the elongate body.

8. The pin punch of claim 1, in combination with a tool.

9. The pin punch and tool of claim 8, wherein the pin punch is storable inside the tool.

10. The pin punch and tool of claim 9, wherein the tool is a hammer and the pin punch is storable in a handle of the hammer.

11. The pin punch and tool of claim 10, wherein
the pin punch is further comprised of a spring-loaded ball detent located near a bottom portion of the pin punch,
the hammer handle has an interior groove inside the handle configured to accept at least a portion of the spring-loaded ball detent, and
a tab is located on a side of the pin punch, opposite the spring-loaded ball detent.

12. The pin punch and tool of claim 11, wherein the hammer handle includes
a punch opening on a bottom surface of the hammer handle, and
a tab opening on a side of the hammer handle, wherein the tab of the pin punch is accessible through the tab opening.

13. The pin punch of claim 1, wherein
the at least one hole is both of
the hole positioned in the side of, and perpendicular to the first axis of, the elongate body, wherein
the hole is defined by a large pin receiver, and
the large pin receiver is perpendicular to the first axis, and
the pin hole positioned in the top face of, and parallel to the first axis of, the elongate body, wherein
the pin hole is part of a set of pin holes, and
the set of pin holes are circumferentially positioned on the top face; and
the magnet is comprised of at least two magnets, wherein
a first of the at least two magnets is positioned adjacent the large pin receiver, and
a second of the at least two magnets is centrally positioned between the set of pin holes.

14. The pin punch of claim 13, wherein
the elongate body is further comprised of a main body and a punch head,
the punch head is connectable to a top portion of the main body,
the main body is comprised of
a main body housing,
the large pin receiver positioned through the main body, and
a main body magnet that is the first of the at least two magnets, and
the punch head is comprised of
a punch head body,
the set of pin holes that are circumferentially positioned on the punch head, and
a punch head magnet that is the second of the at least two magnets.

15. The pin punch of claim 14, wherein the punch head is further comprised of a punch head connector on a bottom portion of the punch head, wherein the punch head connector is structured and configured to connect to the main body.

16. The pin punch of claim 15, wherein the main body is further comprised of a punch head receptacle on a top portion of the main body, wherein the punch head receptacle is structured and configured to connect to the punch head.

17. The pin punch of claim 16, wherein the punch head connector and punch head receptacle are threadedly connectable such that the punch head connector is a threaded, male connector and the punch head receptacle is a female threaded receptacle.

18. The pin punch of claim 16, wherein
the punch head receptacle is adjacent the large pin receiver, and
the main body magnet is positioned on an opposing side of the large pin receiver.

19. The pin punch of claim 18, wherein
the punch head receptacle is internal to the main body and is positioned above the large pin receiver, and
the main body magnet is internal to the main body and is positioned below the large pin receiver.

20. The pin punch of claim 14, wherein
the punch head is comprised of a metal,
a pin is located within a pin hole of the set of pin holes, and
the punch head magnet retains the pin in the pin hole.

21. A tool comprising:
a pin punch, the pin punch comprising
a main body having
a main body housing with a length defined by a first axis,
a large pin receiver defining a through hole positioned through the main body, wherein the large pin receiver is perpendicular to the first axis, and
a main body magnet positioned adjacent the large pin receiver,
a punch head having a punch head body, wherein
a set of pin holes are circumferentially positioned on the punch head,
a punch head magnet is centrally positioned between the set of pin holes, and
the punch head is connectable to a top portion of the main body, and
a spring-loaded ball detent comprised of a ball and a ball detent housing, wherein the spring-loaded ball detent is located near a bottom portion of the pin punch; and
a hammer, the hammer comprising
a hammer head, and
a handle having
an interior space inside which the pin punch is storable,
a punch opening on a bottom surface of the handle, and
an interior groove in the interior space configured to accept at least a portion of the spring-loaded ball detent.

22. A method of using a pin punch, the method comprising:
inserting a pin into a pin hole of a set of pin holes of a pin punch, wherein
the pin punch has a punch head that is connectable to a top portion of a main body of the pin punch,
the set of pin holes are circumferentially positioned on a top portion of the punch head, and
a punch head magnet is centrally positioned between the set of pin holes;
aligning the pin with a firearm pin hole; and
providing blunt force to an end of the pin punch that is opposite the pin to at least partially install the pin in the firearm.

23. The method of claim 22, further comprising inserting the pin punch into a handle of a hammer, wherein the handle has
an interior space inside which the pin punch is storable, and
a punch opening on a bottom surface of the handle.
